(19) United States
(12) Patent Application Publication
(10) Pub. No.: US 2011/0089699 A1
(43) Pub. Date: Apr. 21, 2011

(54) VERTICAL WIND TURBINE HAVING BLADES WITH VARYING GEOMETRY

(75) Inventor: Hans Bernhoff, Uppsala (SE)

(73) Assignee: Vertical Wind AB

(21) Appl. No.: 12/737,146

(22) PCT Filed: Jun. 13, 2008
(86) PCT No.: PCT/SE2008/050713

§ 371 Date: Dec. 13, 2010

(51) Int. Cl. F03D 3/06

(52) U.S. Cl. 290/55

(57) ABSTRACT

The invention relates to a wind turbine with vertical! axis and having a plurality of axlal\ddot{υ}y extending turbine blades (2). According to the invention the structure of each blade varies along the axial extension of the blade (2). The invention also rebates to the use of the wind power unit for generating.

### FIELD OF INVENTION

The present invention in a first aspect relates to a wind turbine with vertical axis and having a plurality of axially extending turbine blades.

In a second aspect the invention relates to the use of a wind power unit having such a wind turbine.

All references in the present application to orientations and locations such as upper, lower etc relate to the orientation of the wind turbine when mounted on a vertical shaft.

The terms axial and radial relate to the turbine axis.

### BACKGROUND OF THE INVENTION

During the last decades the interest for generating electrical energy by using wind turbines has been increased dramatically as a result of the need to exploit alternative sources for that purpose. Most wind turbines, in particular those who have reached commercialization have a horizontal axis and are of the axial flew type.

Although not yet so common, also radial flow turbines with vertical axis are generally known. These so called H-rotors have many advantages in comparison with axial flow turbines, such as a large exposure area towards the wind; independence of the wind direction and the possibility to arrange the generator at the ground. Examples of such wind turbines are disclosed e.g. in U.S. Pat. No. 6,320,273 and U.S. Pat. No. 7,126,235.

In order to attain a wind power unit with vertical axis that is competitive to conventional units having axial flow turbines and to other sources for generating energy it is important to optimize the various elements in such a unit.

The object of the present invention is to optimize the blades of this kind of turbine in respect of the aerodynamic efficiency when capturing the wind energy and in respect of the strength properties.

A blade that is designed to have a maximal efficiency regarding capturing the wind energy will also result in a maximal load on the blade, the elements connecting the blade to the axis and the joints between these elements and the blades.

When designing the blade it is therefore necessary to consider also the strength aspect of the rotor construction to avoid overload on the components thereof. The design of the blade therefore results in a compromise in order to meet the requirements of high efficiency in capturing the wind energy as well as the requirement of limiting the load on the rotor construction.

The contribution to the load from various parts of the blade varies along the axial extension of the blade such that it increases with increasing distance from the joints. This means that for a uniform blade designed with respect to the mentioned compromise, parts of the blade will have a structure that does not reflect an optimal balance in this compromise. For some parts the design results in a comparatively high contribution to the load whereas for other parts the efficiency in capturing the wind energy is unnecessarily much restricted. The compromise therefore is not adequately balanced for most parts of blade since in some parts one of the aspects dominates much and in the other parts the other aspect dominates.

In addition also the crucial aspect of the dynamic stall on the blade has to be taken into consideration, since at stalling the torque will change rapidly.

The present invention is based on the insight resulting from this analysis. The object of the invention is met by designing the rotor blades such that the above mentioned drawbacks entailing a conventional blade design are eliminated.

### SUMMARY OF INVENTION

The object of the present invention thus in the first aspect is achieved in that a wind turbine of the kind initially specified includes the specific features that the structure of each blade varies along the axial extension of the blade.

Since the structure of each blade varies along the axial extension thereof, each part of the blade can be designed with respect to an adequate balanced compromise for that very part. The total power received from a blade thereby will be increased in comparison with a traditionally designed blade. A wind turbine with such blade will therefore have a higher efficiency. By varying the structure of the blade it will also be possible to compensate for the variation in the wind velocity as a function of the altitude. Each part of the blade thus can be optimized in relation to the vertical location of that part.

Important is also that the varying structure will allow varying stalling characteristic along the blade such that stalling does not occur momentary on the complete blade. When dynamic stall instead occurs initially in a certain part, or certain parts of the blade and then gradually reaches the other part rapid changes in the torque can be avoided. This leads to a smoother operation of the turbine and noise and mechanical transients resulting from stall will be reduced. Particularly advantageous thereby is to design the blade such that the dynamic stall initially will occur at the tip ends of the blade and then gradually reach the middle part.

According to a preferred embodiment of the invention the attack angle varies along the axial extension of the blade.

The attack angle is an important parameter in respect of the ability of the blade to capture the wind energy. Varying the attack angle along the blade therefore is one advantageous way of obtaining the variation in structure that represents a balanced compromise in every point of the blade.

According to a further aspect of the invention the cross section perpendicular to the axial direction of the blade varies along the axial extension thereof.

This is an alternative or a complement to varying the attack angle and has the advantage that different parameters of the blade can be varied in order to obtain this variation.

According to a further preferred embodiment the variation of the cross section includes that one, some or all of the following parameters varies, namely the chord length, the width, the profile, the camber and the cross sectional area.

Each of these parameters has an influence on the efficiency of the blade to capture the wind energy. Which of these parameters that are varied and the extent to which each parameter is varied depends on the location, general design and size of the wind turbine in combination with cost consideration.

According to a further preferred embodiment the variation is continuous.

Thereby the balance of the compromise can be optimized for each and every point along the extension of the blade. The continuous variation also reduces the risk for disturbances that would occur if there would be sudden larger variations in the structure.

According to a further preferred embodiment the variation is symmetrical in relation to the axial middle point of the blade such that the upper and lower halves of the blade are identical.

Since the connection to the shaft normally is symmetrical with respect to a horizontal plane through the middle of the blade, a variation of the blade structure reflecting this symmetrical arrangement is normally the best solution to reach the main function of the variation.

According to a further preferred embodiment each blade is connected to the axis by an arm system having at least two connecting joints to the blade and the blade has a maximum of its cross sectional area and/or its ratio between the width and the chord at each joint.

According to a further preferred embodiment the structure of the blade varies with respect to its stalling characteristic.

By focusing on this very aspect when providing the varying structure of the blade the wind turbine will be optimized to cope with the dynamic stall. For certain application this might be the dominant aspect to consider, in particular when it is necessary to reduce the noise and mechanical transients. When varying the structure for obtaining the varying stalling characteristic one or more of the various parameters mentioned above can be varied.

The bending forces on the blade itself has a maximum at these points. The force from the wind directly acting on the part of the blade located at these points contribute at a minimum to the load on the arm system. In respect of both these aspects it is advantageous that one or both of the said two parameters are maximized in this regions

According to a further preferred embodiment the joints divides the blade in an upper section, a lower section and a middle section, wherein the cross sectional area and/or the ratio between the width and the chord length of the upper section and the lower section decreases towards the outer end of the respective section and wherein the cross sectional area and/or the ratio between the width and the chord length of the middle section decreases from each joint towards the axial middle point of the blade.

With this configuration of how the structure of the blade varies, the principle of the present invention is optimally applied to the complete blade such as a very high efficiency is obtained.

According to a further preferred embodiment the ratio between the width and the chord length is in the range of 0.17 to 0.29 at the joints, and is in the range of 0.09 to 0.16 at each axial end of the blade.

A ratio within these ranges for the respective point represents an optimum for each of these point as well as for those in between, and an optimum for the variation of the relation between these ratios. It is to be understood that this ratio continuously decreases from the joints towards the blade ends. Within these ranges the optimum in most case will be within 0.20 to 0.24 and within 0.11 to 0.13 respectively.

According to a further preferred embodiment the distance between the joints is in the range of 40% to 60% of the axial extension of the blade.

Thereby the blade is divided such that the middle section will be approximately half the blade and the other sections one fourth each. These proportions are favourable to minimize the loads on the blade and the joints.

The above preferred embodiments of the invented wind turbine are set out in the dependent claims.

The invention also relates to a wind power unit including a wind turbine according to the invention, and in particular to any of the preferred embodiment thereof.

Further, the invention relates to an electrical network connected to a wind power unit according to the present invention.

By the invented wind power unit and the invented network, advantages are gained that corresponds to those of the invented wind turbine and the preferred embodiments thereof, and which have been described above.

In a second aspect of the invention the object is achieved in that the invented wind power unit is used for generating electrical energy thereby gaining the corresponding advantages.

The invention will be further explained by the following detailed description of examples thereof, and with reference to the accompanying drawings.

### BRIEF DESCRIPTION OF THE DRAWINGS

FIG. 1 in a schematical side view illustrates a wind power unit with a wind turbine 1 according to the invention. The turbine consists of three vertical turbine blades 2 each one connected by arms 3 to a central shaft 4 with vertical axis journalled in a framework 5. The shaft 4 is connected to a generator 6.

FIG. 2 is a side view of one of the blades in an enlarged scale. The two arms 3 connecting the blade 2 to the axis divide the blade into an upper section 21, a lower section 22 and a middle section 23. The middle section 23 represents about 50% of the axial extension of the blade and the upper 21 and lower section represent 25% each.

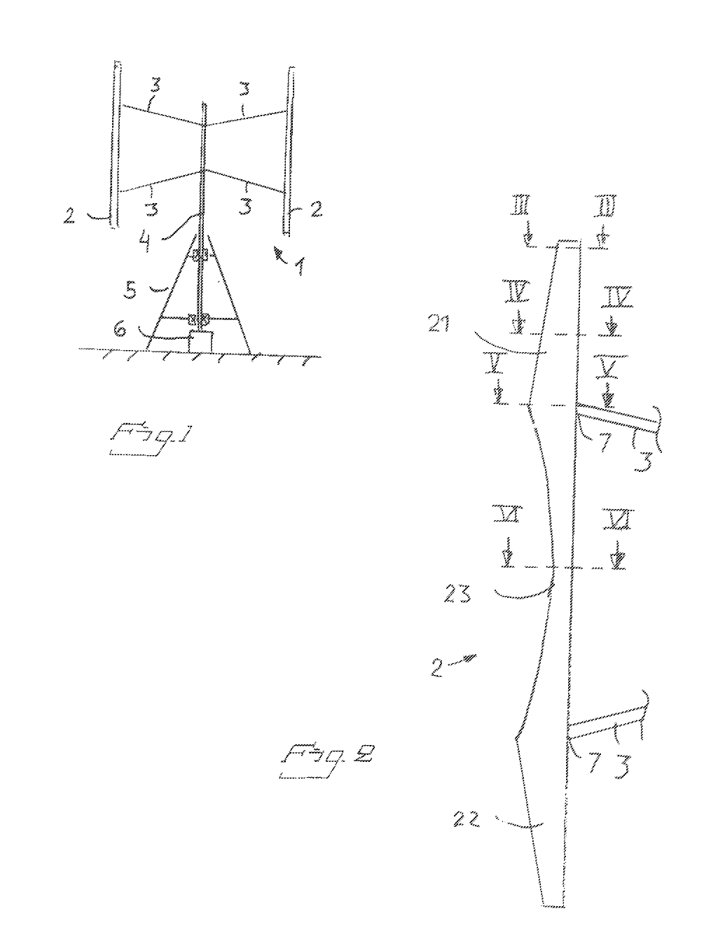

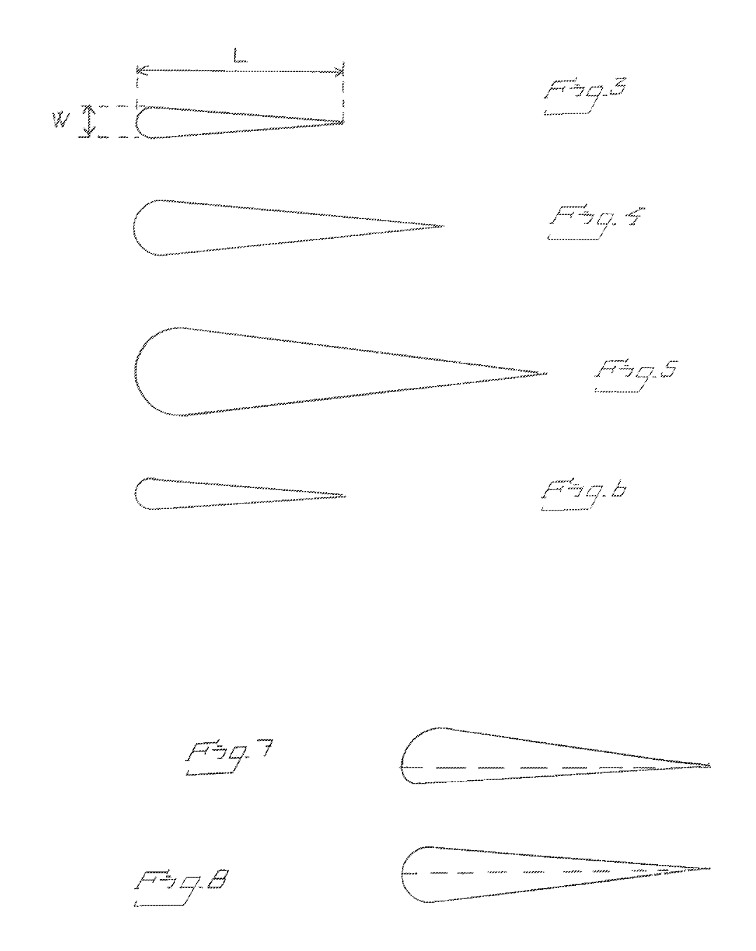

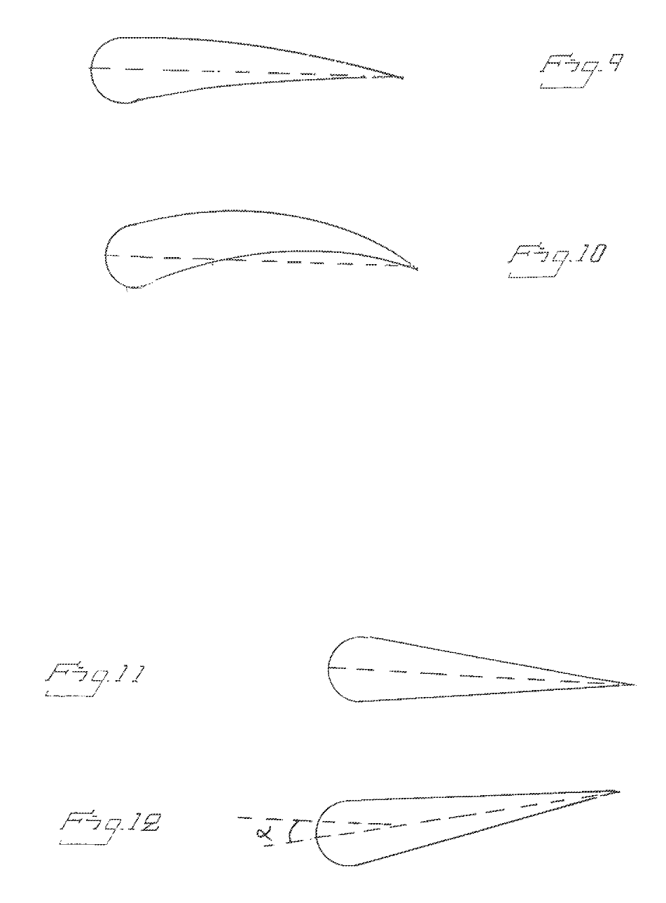

As can be seen, the chord length of the blade 2 varies along the axial extension thereof. It has a maximum at each joint 7 where the blade is connected to its respective arm 3. The chord length of the upper 21 and lower 22 sections decreases continuously from the respective joint 7 towards the tip. The chord length of the middle section 23 decreases from each joint towards the axial middle of the blade, where the chord length has a minimum.

The width of the blade 2 also varies along the axial extension thereof in a corresponding manner. The variation of the width is more accentuated than that of the chord length such that the ratio blade width to chord length also varies.

FIGS. 3 to 6 are sections taken along lines III-III to VI-VI respectively which illustrate how the cross section of the blade varies. In the table below the width (W), the chord length (L) and the ratio between these are set out for each of the sections in centimetres.

| FIG. No | W | L | W/L |
|---|---|---|---|
| 3 | 6 | 50 | 0.12 |
| 4 | 13 | 75 | 0.17 |
| 5 | 22 | 100 | 0.22 |
| 6 | 6 | 50 | 0.12 |

In the example illustrated in FIGS. 3 to 6 thus the parameters width, chord length, the ratio between width and chord length and the cross sectional area are varied, whereas the camber and the attack angle remain the same.

FIGS. 7 and 8 illustrate a second example of the invention where the camber varies along the axial extension of the blade. FIG. 7 is a cross section adjacent the upper tip of the blade and FIG. 8 is a cross section at the upper joint with the arm. In this example only the camber varies, whereas the width and the chord length remains substantially the same. At the joint the profile is symmetric (FIG. 8) and at the blade tip (FIG. 7) the profile is asymmetric.

An alternative example of varying camber is illustrated in FIGS. 9 and 10. FIG. 9 illustrates the cross section at the tip. The profile is asymmetric having one side almost planar. The cross section at the joint is illustrated in FIG. 10, where one side is concave.

FIGS. 11 and 12 illustrate a further example. The blade has constant profile and constant dimensions, whereas the attack angle varies such that it is zero adjacent the tip (FIG. 11) and α at the joint (FIG. 12).

It is to be understood that the various examples given above for how the is structure of the blade can vary can be combined with each other.

1. A wind turbine (1) with vertical axis and having a plurality of axially extending turbine blades (2), characterized in that the structure of each blade (2) varies along the axial extension of the blade.

2. A wind turbine according to claim 1, characterized in that the attack angle (α) varies along the axial extension of the blade.

3. A wind turbine according to claim 1 or 2, characterized in that the cross section perpendicular to the axial direction of the blade (2) varies along the axial extension of the blade.

4. A wind turbine according to claim 3, characterized in that the variation of the cross section includes that one, some or all of the following parameters varies, namely the chord length, the width, the profile, the camber and the cross sectional area.

5. A wind turbine according to any of claims 1-4, characterized in that the variation is continuous.

6. A wind turbine according to any of claims 1-5, characterized in that the variation is symmetrical in relation to the axial middle point of the blade such that the upper and lower halves of the blade are identical.

7. A wind turbine according to any of claims 1-6 characterized in that the structure of the blade varies with respect to its stalling characteristic.

8. A wind turbine according to any of claims 1-7, characterized in that each blade is connected to the axis by an arm system (3) having at least two connecting joints (7) to the blade (2) and in that the cross sectional area and/or the ratio between the width and the chord length of the blade (2) has a maximum at each joint (7).

9. A wind turbine according to claim 8, characterized in that the joints (7) divides the blade (2) in an upper section (21), a lower section (22) and a middle section (23) wherein the cross sectional area and/or the ratio between the width and the chord length of the upper section (21) and the lower section (22) decreases from the respective joint (7) towards the outer end of the respective section and wherein the cross sectional area and/or the ratio between the width and the chord length of the middle section (23) decreases from each joint (7) towards the axial middle point of the blade (2).

10. A wind turbine according to any of claim 8 or 9, characterized in that the ratio between the width and the chord length is in the range of 0.17 to 0.29 preferably in the range of 0.20 to 0.24 at the joints (7), and is in the range of 0.09 to 0.16 at each axial end of the blade (2), preferably in the range of 0.11 to 0.13.

11. A wind turbine according to any of claims 8-10, characterized in that the distance between the joints (7) is in the range of 40% to 60% of the axial extension of the blade (2).

12. A wind power unit characterized in that it includes a wind turbine according to any of claims 1-11.

13. An electrical network characterized in that it is connected to a wind power unit according to claim 12.

14. The use of a wind power unit according to claim 12 for generating electrical energy.
